(19) United States
(12) Patent Application Publication
(10) Pub. No.: US 2021/0192415 A1
(43) Pub. Date: Jun. 24, 2021

(54) BRAND PROXIMITY SCORE

(71) Applicant: Ushur, Inc., Santa Clara, CA (US)

(72) Inventors: Simha Sadasiva, San Jose, CA (US); Wenyi Tao, Fremont, CA (US); Henry Thomas Peter, Mountain House, CA (US)

(21) Appl. No.: 17/127,412

(22) Filed: Dec. 18, 2020

Related U.S. Application Data
(60) Provisional application No. 62/951,707, filed on Dec. 20, 2019.

(51) Int. Cl. G06Q 10/06; G06Q 30/02; G06Q 10/10; G06F 16/22; G06N 20/00

(52) U.S. Cl. CPC G06Q 10/06393; G06Q 30/0201; G06Q 10/0637; G06Q 30/016; G06F 16/2228; G06N 20/00; G06Q 10/10

(57) ABSTRACT

Methods and systems for automatically assessing proximity of an enterprise's brand to a customer are disclosed. A processing device obtains a first sub-score indicative of a degree of completion of a task that involves the enterprise providing a service to the customer, a second sub-score indicative of a level of user engagement between the enterprise and the customer, and a third sub-score indicative of efficiency of the task that involves the enterprise providing the service to the customer. The processing device then combines the first sub-score, the second sub-score and the third sub-score to determine a composite brand proximity score (BPS) indicative of the proximity of the enterprise's brand to the customer.

### RELATED APPLICATION

This application claims the benefit of U.S. Provisional Patent Application No. 62/951,707, filed Dec. 20, 2019, entitled, “BRAND PROXIMITY SCORE FOR TASK AUTOMATION PLATFORM,” the entirety of which is incorporated herein by reference.

### TECHNICAL FIELD

Embodiments of the disclosure relate generally to task automation, and specifically to a score that reflects how proximal a brand of an enterprise is to a customer base.

### BACKGROUND

Traditional customer surveys and scores created from those surveys involve enterprises explicitly asking the customers on the experience and/or how the customer will act in the future, such as recommending the enterprise's services or goods to their networks and friends. However, the traditional methods lack the ability to intelligently and automatically harness information from the customers over a period of time in a non-invasive way as the workflow progresses towards completion of a task.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

Enterprises leverage service engagement platforms (sometimes simply called a service platform, or user engagement platform) to interact with their customers. Service engagement platforms automate the enterprise workflow, interact with customers to broker information and build proximity with customers through conversations. The enterprise workflow is task-oriented. Examples of task may include booking a ticket, registering an account, resolving a claim, collecting user feedback etc.

The service engagement platform disclosed here may use various mechanisms such as chatbots, conversational artificial intelligence (AI) etc. for conversing with the customers while improving workflow efficiency. The service engagement platform automates at least parts of the enterprise workflow, interacts with customers to broker information and builds proximity with customers through conversations. The enterprise workflow is task-oriented. Examples of task may include booking a ticket, registering an account, resolving a claim, collecting user feedback etc.

The service engagement platform supports two-way text-based interaction centered around business-necessitated engagements between enterprises with their customers as they interact over a period of time. Note that the term ‘enterprise’ broadly encompasses an entity (which can be a business entity or a person) who serves a customer. The customer is sometimes referred to as ‘end-user’ or simply user, though based on the context, the term ‘user’ may also indicate the entity that is referred to as an enterprise elsewhere. Based on customer engagements and behaviors, the service engagement platform described here gradually derives a score that would convey how proximal the brand of the enterprise is to their customer base. This score is expected to be a standard of measurement for enterprises getting into a complete messaging-based interaction with their customers.

Generally speaking, a Brand Proximity Index (BPI) reflects how well an enterprise builds its relationship with its customer base over time. The BPI is computed from each individual customer interaction and each conversation flow has a brand proximity score (BPS).

The brand proximity score computation combines statistical processing and machine learning. Some of the important aspects that are taken into consideration are: overall task completion, the level of the customer's engagement and the efficiency of the system.

The measure of engagement is data-driven and uses the historical multi-turn conversational data to estimate the continuation to respond to each module. Multi-turn conversational modelling concatenates contextual utterances to ensure conversation consistency. The more effort it takes for a customer to respond, the higher the engagement score. A long text response from a customer will have a higher engagement score than a single click on a multiple choice tab. This is regardless of the content of the response such as a negative feedback. The level of engagement also incorporates the response time. Generally, short response time will have a higher engagement score than a lagged response time when all other conditions are the same. A task efficiency score will incorporate the system latency and heavily depend on whether the task is completed and the number of steps it took to complete. For a successfully completed task, the more steps it takes, the score will be slightly lower than those with fewer steps. For a task that is not completed, the task efficiency score significantly suffers and give score credits for each additional step it has completed so far.

Specifically, an aspect of the present disclosure describes methods and systems for automatically assessing proximity of an enterprise's brand to a customer. A processing device obtains a first sub-score indicative of a degree of completion of a task that involves the enterprise providing a service to the customer, a second sub-score indicative of a level of user engagement between the enterprise and the customer, and a third sub-score indicative of efficiency of the task that involves the enterprise providing the service to the customer. The processing device then combines the first sub-score, the second sub-score and the third sub-score to determine a composite brand proximity score (BPS) indicative of the proximity of the enterprise's brand to the customer.

Note that the term “service” is broadly interpreted to encompass providing information about or delivery of tangible goods too. Also, the term “user engagement” means engagement with a customer of the enterprise, where an “enterprise” can be an organization, or an individual, or a team of individuals that provide the service to the customer. Also, the term score is used generically, though when a score has multiple components, those multiple components can be indicated as sub-score.

### BRIEF DESCRIPTION OF THE DRAWINGS

The present disclosure will be understood more fully from the detailed description given below and from the accompanying drawings of various embodiments of the disclosure.

FIG. 1 illustrates an enterprise's workflow, according to an embodiment of the present disclosure.

FIG. 2 illustrates a scoring engine layout, according to an embodiment of the present disclosure.

FIG. 3 illustrates an engagement score component and an efficiency score component, according to embodiments of the present disclosure.

FIG. 4 illustrates choosing a score function, according to an embodiment of the present disclosure.

FIG. 5 illustrates in a tabular form how various factors influence each score component, according to an embodiment of the present disclosure.

FIG. 6 is a graphical representation of an expert's belief on the distribution of the engaging turns, according to an embodiment of the present disclosure.

FIG. 7 is plot of a quick response reward function, in accordance with embodiments of the present disclosure.

FIG. 8 is plot of a memorizing reward step function, in accordance with embodiments of the present disclosure.

FIG. 9 is a flow diagram of an example method 900 of BPS generation as implemented by a component operating in accordance with some embodiments of the present disclosure.

FIG. 10 illustrates an example machine of a computer system within which a set of instructions, for causing the machine to perform any one or more of the methodologies discussed herein, can be executed.

### DETAILED DESCRIPTION

Embodiments of the present disclosure are directed to determining a score indicative of how an enterprise's brand becomes proximal to a customer (or end-user) over time via progressive interactions.

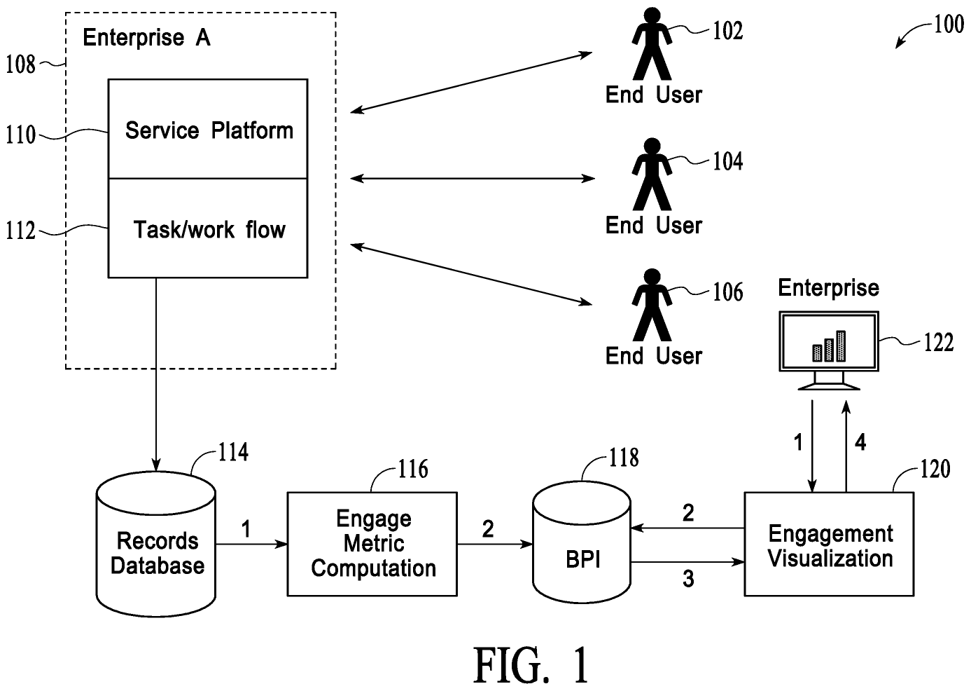

FIG. 1 illustrates an enterprise's workflow block diagram 100, according to an embodiment of the present disclosure. The customer (also called user or end-user) interacts via the service platform 110 with the enterprise's task workflow 112. The service platform 110 and task/workflow 112 together represent the enterprise's user engagement interface 108. Each end-user (such as the three end-users 102, 104, and 106 shown here as an example, though any number of end-users can be supported) interaction and system execution records are logged and stored into the engagement record database 114 (e.g., a persistent database). The latest sequence of records are periodically retrieved (arrow marked 1) and brand proximity scores (BPS) are computed based on those interaction records. This operation is shown as engage metric computation 116. The score is updated and inserted (arrow marked 2) in a separate database (BPI database 118), where BPI is an abbreviation of Brand Proximity Index, elaborated below. The enterprise viewer sends a request to an engagement visualization engine 120 (as indicated by arrow marked 3) which sends a query (as indicated by the arrow marked 2 going to the BPI database 118) to the BPI database and the scores are sent back to an enterprise view in a machine 122 (arrow marked 4).

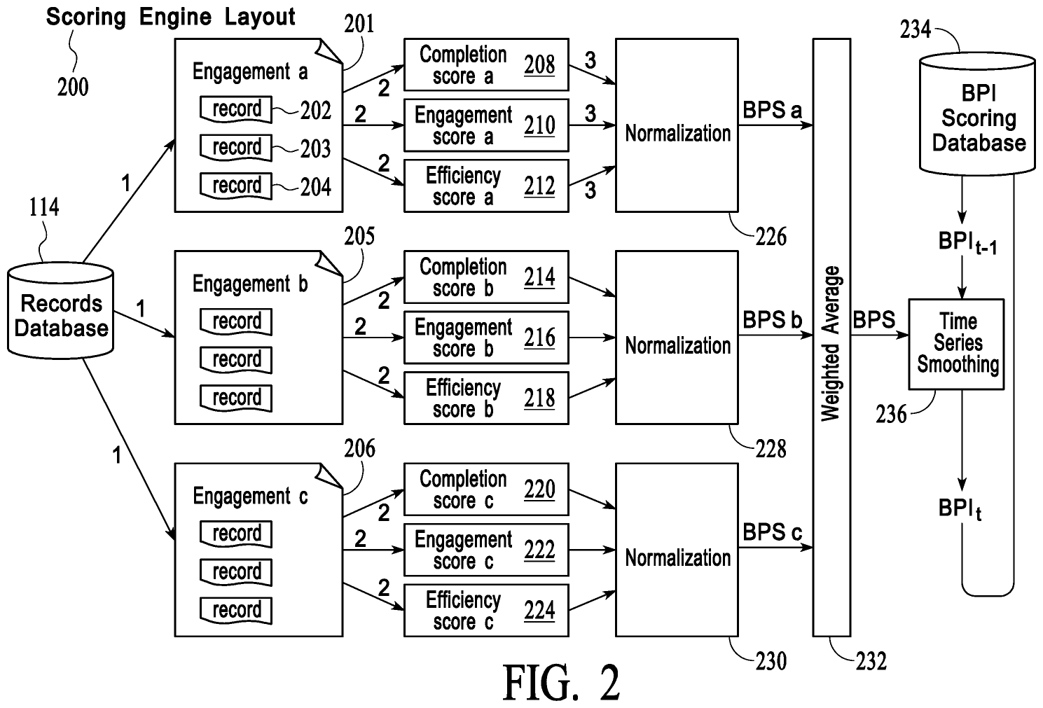

FIG. 2 illustrates a scoring engine layout 200, according to an embodiment of the present disclosure. The records of engagement are fetched (shown as arrows marked 1) from a records database 114 and sorted by end-user session identifying indicia (abbreviated as session id). For example, records for engagement a with an end-user could be sorted as 201 having indivudual record components 202, 204 and 204. For each engagement, a sequence of machine and user interaction records are sorted in ascending timestamp order and then a copy of session engagement is passed through multiple scoring components (shown as arrows marked 2). For example, in an example where three scoring components are used, the individual components can be a completion score (208), an engagement score (210), and an efficiency score (212) are normalized (226) and generates a BPS score ‘BPS_a’. Similarly, engagement b (205) creates its own completion score 214, engagement score 216, and efficiency score 218, which are normalized (228) to generate a BPS score ‘BPS_b’. Similarly, engagement c (206) creates its own completion score 220, engagement score 222, and efficiency score 224, which are normalized (230) to generate a BPS score ‘BPS_c’. The individual BPS score for a, b, c are weighted (232) based on their relative importance and yield an overall brand proximity score (BPS) with the engagement at time t. This is explained further below.

The other engagement records that fall into the same time window (t, t+delta) are computed in the same manner and the BPS_a, BPS_b, BPS_c etc will be weighted based on the activeness of the end-users. The enterprise level BPS at time t is computed along with the BPI from last period time (i.e. at time (t−1)) as retrieved from BPI scoring database 234. In one embodiment, the moving average of the last K periods can be used as one of the time series smoothing (236) method which yields a more robust estimate.

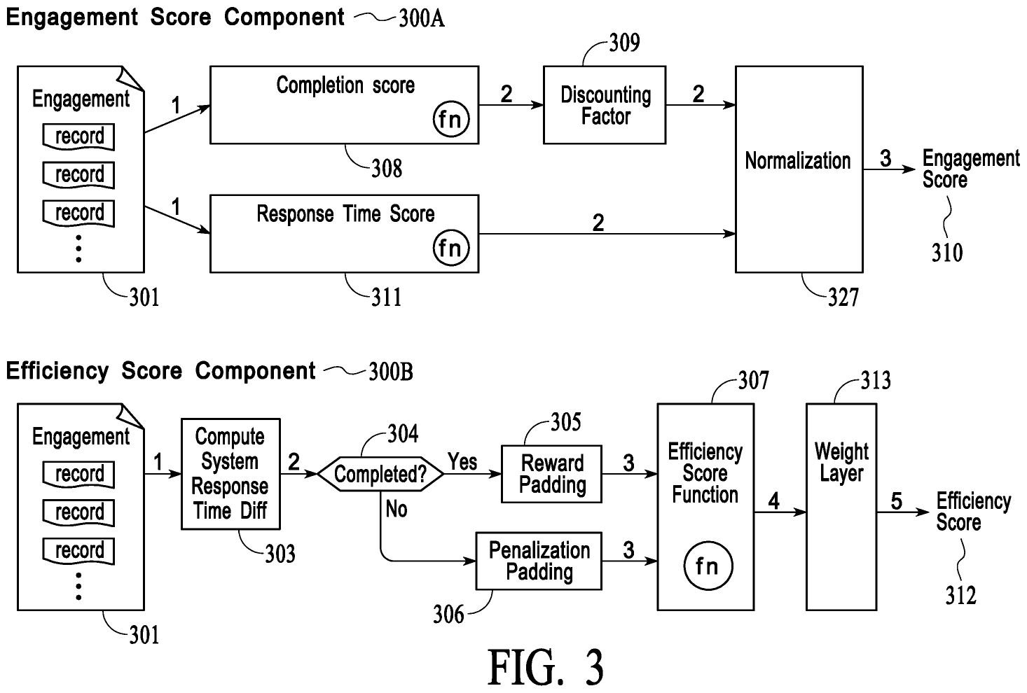

FIG. 3 illustrates an engagement score component 300A and an efficiency score component 300B, according to embodiments of the present disclosure. The completion score component 308 created from the engagement record 301 gives a constant score to the engagement which is evaluated as completed. The flow is marked as completed if the interaction passed through a set of predefined workflow sections.

The engagement score component 300A is based on two sub-components. The continuation score function indicated within the completion score component 308 gives a high score to a deeper engagement with a discounting factor 309. The response time reward function within the response time score component 311 assigns a high score for short average user response time. Normalization 327 is applied to calculate the engagement score 310.

The efficiency score component 300B evaluates how well the workflow system handles the end-user's response and whether the primary objective is achieved or not. The response time for each system interaction is stored in an array in 303. If the session is evaluated as completed at the decision block 304, the response time array is padded with 0 (at reward padding block 305), otherwise, the response time array is padded with ‘infinite’ (at penalization padding block 306). The exponential score function takes the conceptual infinite and yields 0 score for that step. The temporary array which stores the system response time at each step is passed to the efficiency scoring component 307, and then a weighted layer 313 which puts a higher weight on the critical interaction step. The prior probability for an end-user to continue at each step pⱼ[u] can be used as weights. The efficiency score 312 is output as a result of these operations.

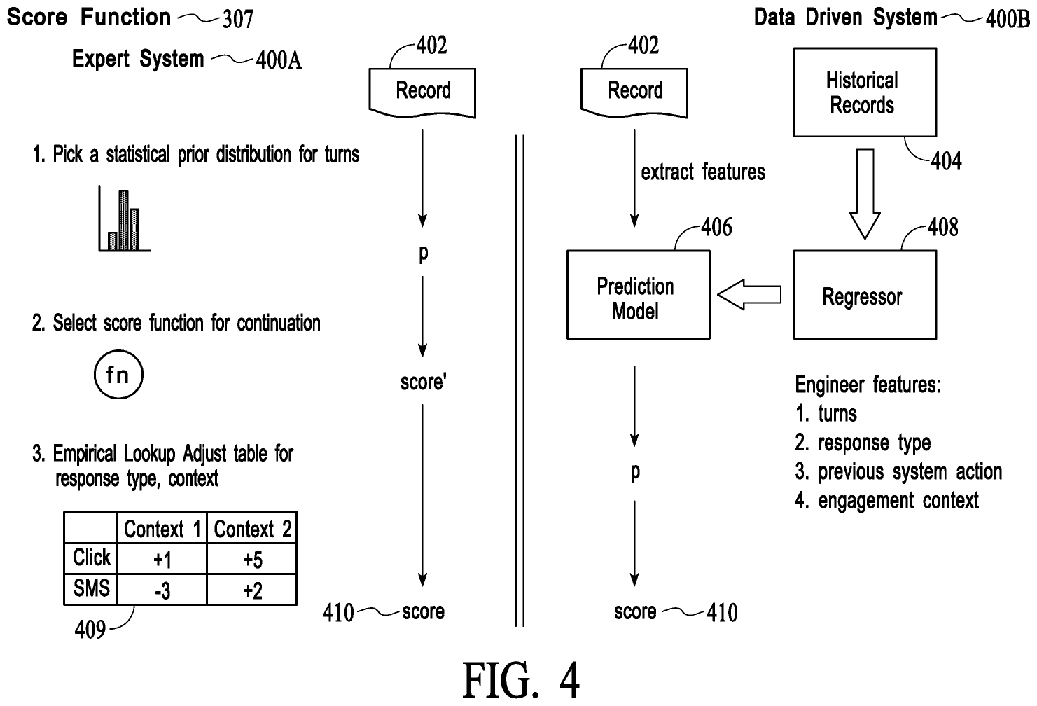

FIG. 4 illustrates choosing a score function, according to an embodiment of the present disclosure. The choice of scoring function depends on the presence of a substantial amount of the historical dataset. With a variety of historical engagement records, the maximum likelihood estimate of the probability for a user to continue at one state is more data driven (shown as 400B in the right half of FIG. 4) than the human preference. However, the empirical expert scoring system (shown as 400A in the left half of FIG. 4) is a hands-on approach with a set of carefully crafted prior distributions. The choice of parameter of prior distribution (e.g., a statistical prior distribution for turns in a multi-turn conversation) represents the expert's belief on how the data distribution looks like (step 1). A score function can also be selected for continuation (step 2). The lookup scoring table (e.g., table 409) also gives flexibility to compare different types of interaction and the application context. Examples of context can be ‘clicks’ on weblinks or SMS messages. The end goal for both 400A and 400B is to generate a score 410 from the engagement record 402. But the data-driven system 400B uses historical records 404, a regressor component 408 to extract features, and a suitable prediction model 406 without the need for an expert's belief, i.e. the process is more automatic than a combination of manual and automatic.

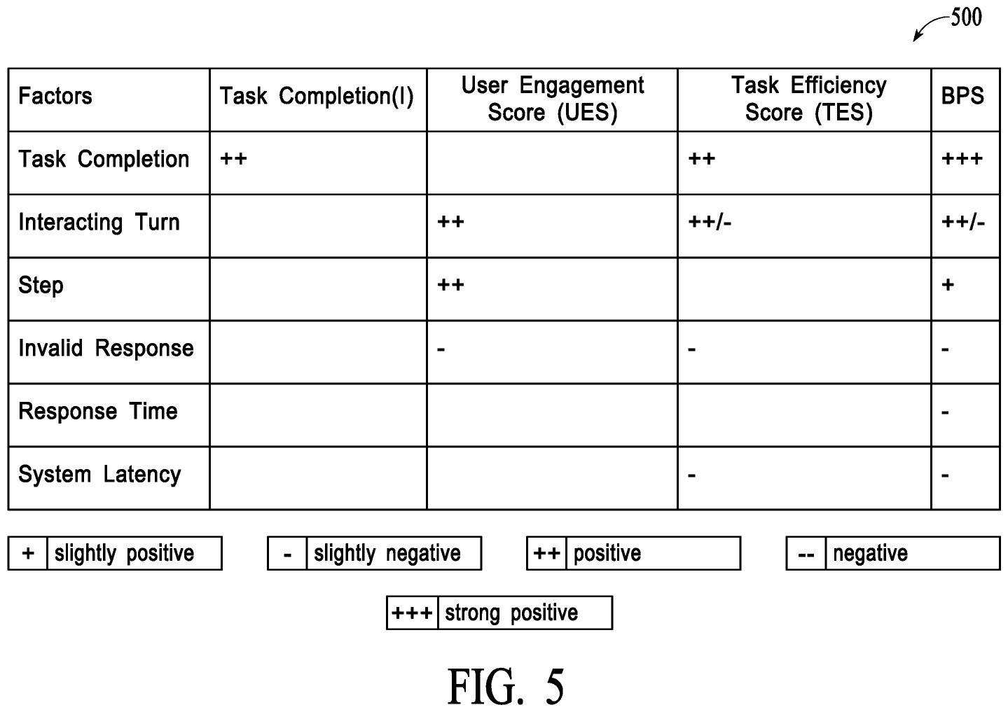

FIG. 5 is a table 500 showing how the various factors influence each score component. After running a set of experiments with the parameter chosen, the BPS score for each interaction depends on the following factors: task completion, interacting turn, step, invalid response, response time, and system latency. The table 500 in FIG. 5 represents how sensitive the BPS score is (i.e. how the BPS score reacts) to the changes in these factors. For example, system latency negatively impacts only the task efficiency score, and not the task completion and user engagement scores. But the overall BPS score is still negatively impacted (as shown in the last row).

The brand proximity score (BPS) of one engagement is a linear combination of three sub-scores: Task Completion(I) sun-score, User Engagement Score (UES) and Task Efficiency Score(TES):

BPSᵢ=Iᵢ+α*UESᵢ+β*TESᵢ

The corresponding weight α and β are scaling parameters and reflect the relative importance.

Iᵢ is a binary variable. It measure whether the task is completed or not. If the conversational flow goes through one of the pre-defined success nodes or modules, the score is 1, else the score is 0. For example, in a credit-card payment section, last question section of a survey etc. indicates task completion.

$${I}_{i} = \{ \begin{matrix}1 & task is completed \\ 0 & task is not completed\end{matrix}$$

UESᵢ is designed to evaluate the level of engagement per session. The score takes two aspects into account: the steps the flow has gone through and the user response time at each step.

The system can set a probability function pⱼ[u] to represent the prior belief of whether the user will continue at the step j. The pⱼ[u] will be influenced by a few categorical variables. e.g. Tᵢ>j−1 total turns larger than previous turn, Nᵢ number of finite user-defined steps and Cⱼ types of response for turn j. The p₄[u] is the expected value of a Bernoulli distribution conditioned on several variables.

$${δ}_{j} = \{ \begin{matrix}1 & j th turn has response \\ 0 & otherwise\end{matrix} \\ {P}_{j}^{[ u ]} = Pr ( {δ}_{j} = 1 \text{\textbar} {T}_{i} > j - 1 , j , {N}_{i} , {C}_{j} )$$

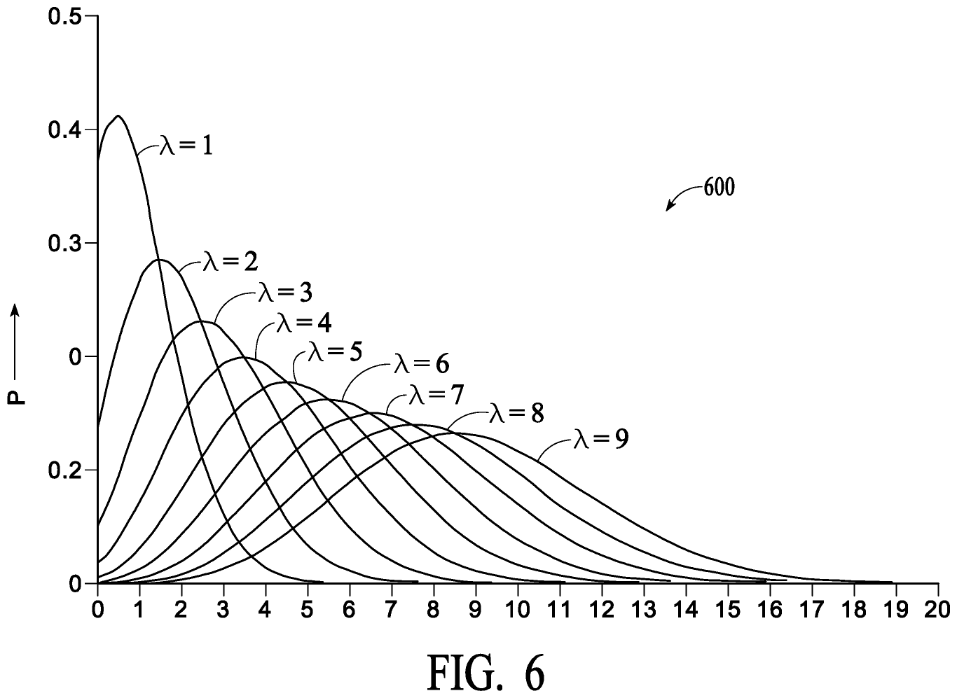

pⱼ^{[u]} can be estimated by regression over a training dataset. If we don't have sufficient data to get a robust estimate, an alternative way to compute pⱼ^{[u]} uses a prior distribution, e.g. Poisson's distribution (with varying values of lambda λ), which reflect the expert's belief on the distribution of the engaging turns. This is shown by the set of plots 600 in FIG. 6. Later on, the parameter lambda can be reset by the mean of the posterior distribution.

In general, g₀(p) is a decreasing score function which assigns a high score to a lower p value. As it is compared with all the other candidates, this engagement is pushed further.

The selection of a scoring function is not an exact science. For example, the drop out rate g₀(p)=1−p is a possible candidate which is naturally bounded within (0, 1), beta(α=2, β=0.98) can also be used for non-linearity assumption.

The total score for the steps will be a summation of each individual response score,

Σⱼ₌₁^{T}^{ᵢ} g₀(pⱼ^{[u]})*γⁿ^{ⱼ}⁻¹

where, γ is a discounting factor and nⱼ is the repetitive times for the same module due to validation. The discounting factor was introduced for repetitive validation engagement because some module requires strict input format (MM/DD/YYYY) etc. Those user responses demonstrate that the user continue to engage with the system but those activities will lead to unbounded scoring. The discounting factor will ensure the engaging score will have an upper bound.

In some embodiments, g₁(tₜᵣᵢₘ) is an exponential score function used in the score calculation, which takes in a trimmed average of user engagement response time for all messages in one session.

$${t}_{trim}^{-} = \frac{1}{{T}_{i} - 2 o} {\sum }_{k = o + 1}^{{T}_{i} - o} {t}_{k}^{[ u ]} .$$

O is set to 1 and tₖ is ordered by value. The general concept is that the quicker the average response time, the more engaged the user is.

Another type of function, g₂(maxₖ(tₖ^{[u]})) is a step function to give the memorizing reward for a user to return back to engage with the system without a reminder. As the user might be in a situation that he was distracted by something else, and later he remember to continue to engage with the system and finish the flow.

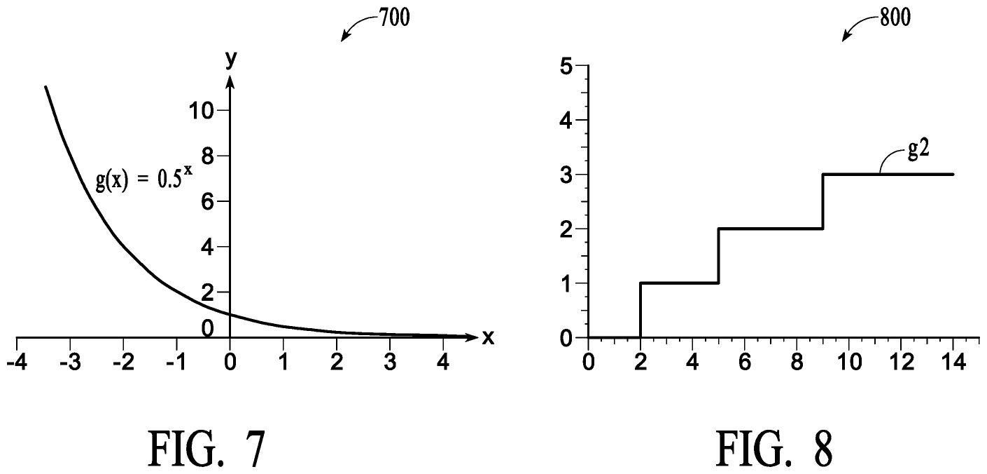

FIG. 7 shows the plot 700 of g₁ which is the quick response reward function and FIG. 8 shows the plot 800 of g₂ which is the memorizing reward step function.

To sum up, the user engagement score for one session i:

$${UES}_{i} = {\sum }_{j = 1}^{{T}_{i}} {g}_{0} ( {p}_{j}^{[ u ]} ) * {γ}^{{n}_{j} - 1} + {g}_{1} ( \frac{1}{{T}_{i} - 2 o} {\sum }_{k = o + 1}^{{T}_{i} - o} {t}_{k}^{[ u ]} ) + {g}_{2} ( {max}_{k} ( {t}_{k}^{[ u ]} ) )$$

Tᵢ is the total user responses for session i. For the task efficiency score, g₃ (tⱼ^{[s]}) is an exponential function takes in the system response time at step j and yield a score. The longer the system responded back, the lower the score. However the penalization for a lagged system response at different stages and modules will be different. The relative importance the module plays in the full workflow can be applied here with a proper parameter setting. Another way is to utilize the prior probability pⱼ^{[u]} the user continue at step j. When the conversation starts, the user has a higher chance to continually engage as they want to explore, a lagged system response at an earlier stage will raise the probability of discontinuation. The discontinuation at an earlier stage can be penalized with more weights according to the following equation:.

$${TES}_{i} = {\sum }_{j = 1}^{{T}_{i}} {g}_{3} ( {t}_{j}^{[ s ]} ) * {p}_{j}^{[ u ]} + 1 ( {I}_{i} = 1 ) ( {\sum }_{j = {T}_{i} + 1}^{K} {g}_{3} ( 0 ) {p}_{j}^{[ u ]} ) + 1 ( {I}_{i} = 0 ) ( {\sum }_{j = {T}_{i} + 1}^{K} {g}_{3} ( ∞ ) {p}_{j}^{[ u ]} )$$

K is a fixed parameter set to be higher than the length of all the engagements. If it is a completed session, padded the rest of the array with K-Tⱼ default system responses and set each response time to 0. If the task flow is not completed, the padded system response time will be set to infinite.

The BPS for an enterprise at time window t is an average of the user engagements at that time window.

$${BPS}_{t} = {\sum }_{u}^{{N}_{u}} {BPS}_{ut} / {N}_{ut}$$

$$u ∈ \{ user 1 , user 2 , user 3 , … \}$$

the BPI (brand proximity index) at time t will be a combination of latest BPS and historical stock value.

BPIₜ=BPSₜ*0.7+BPSₜ₋₁*0.2+BPSᵢ₋₂*0.1; i ∈ {1, 2, 3, . . . }

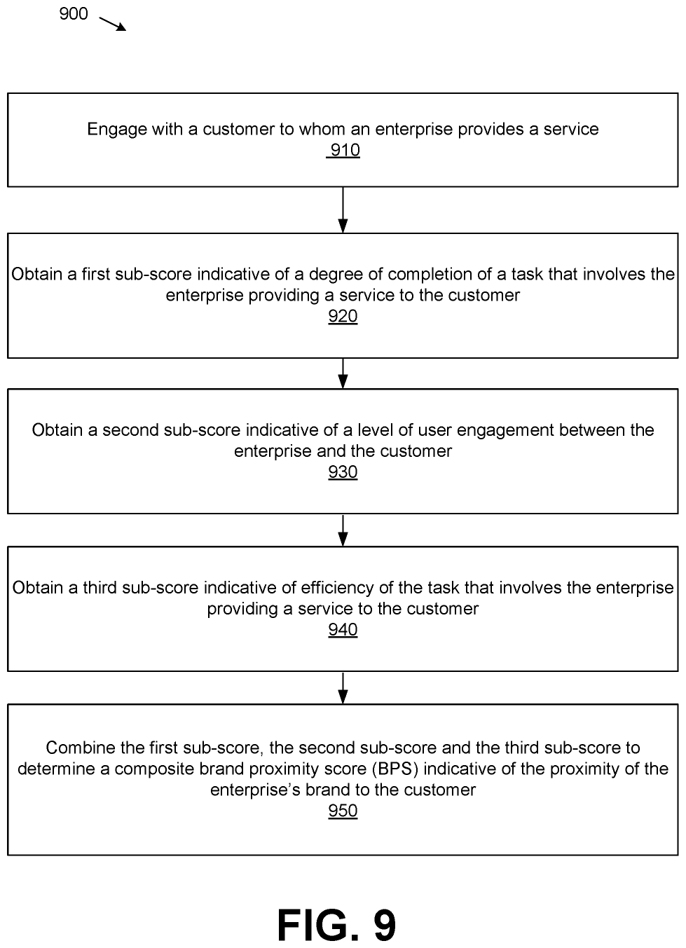

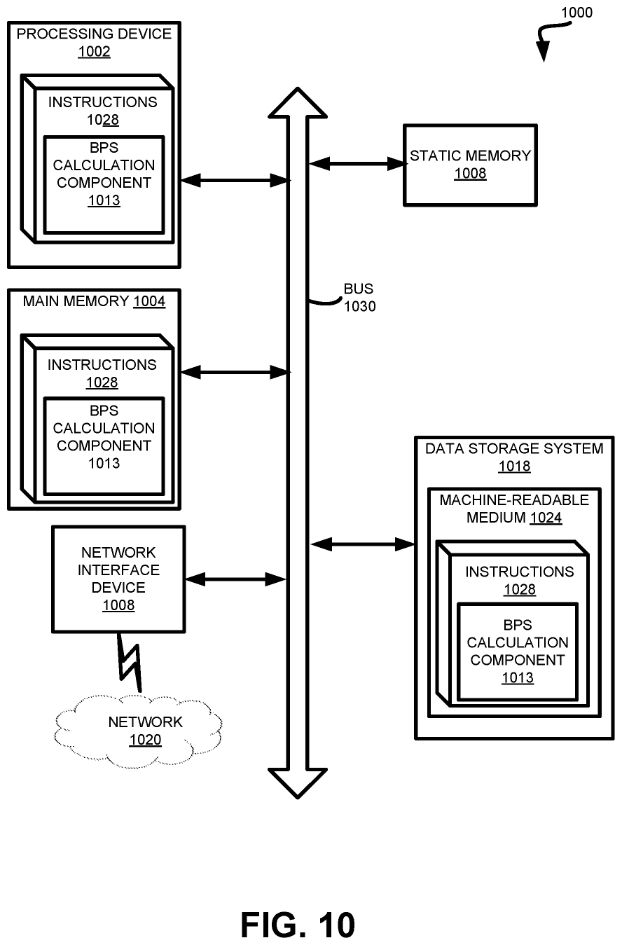

FIG. 9 is a flow diagram of an example high-level method 900 of BPS generation as implemented by a component operating in accordance with some embodiments of the present disclosure. The method 900 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 900 is performed by the BPS calculation component 1013 shown in FIG. 10. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 910, the enterprise engages with a customer to whom the enterprise provides a service. Note that the term “service” is broadly interpreted to encompass providing information about or delivery of tangible goods too.

At operation 920, a first sub-score is obtained, as described above, the first sub-score being indicative of a degree of completion of a task that involves the enterprise providing the service to the customer.

At operation 930, a second sub-score is obtained, as described above, the second sub-score being indicative of a level of user engagement between the enterprise and the customer.

At operation 940, a third sub-score is obtained, as described above, the third sub-score being indicative of efficiency of the task that involves the enterprise providing the service to the customer.

At operation 950, the processing device combines the first, second and the third sub-scores to determine a composite BPS indicative of the proximity of the enterprise's brand to the customer.

FIG. 10 illustrates an example machine of a computer system 1000 within which a set of instructions, for causing the machine to perform any one or more of the methodologies discussed herein, can be executed. In some embodiments, the computer system 1000 can correspond to a host system that includes, is coupled to, or utilizes a memory sub-system or can be used to perform the operations of a processor (e.g., to execute an operating system to perform operations corresponding to a BPS generation, also referred to as BPS calculation component 1013). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a static memory 1008 (e.g., flash memory, static random access memory (SRAM), etc.), and a data storage system 1018, which communicate with each other via a bus 1030.

Processing device 1002 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 can also be one or more special-purpose processing devices such as an application specific integrated circuit (ASIC), a field programmable gate array (FPGA), a digital signal processor (DSP), network processor, or the like. The processing device 1002 is configured to execute instructions 1028 for performing the operations and steps discussed herein. The computer system 1000 can further include a network interface device 1008 to communicate over the network 1020.

The data storage system 1018 can include a machine-readable storage medium 1024 (also known as a computer-readable medium) on which is stored one or more sets of instructions 1028 or software embodying any one or more of the methodologies or functions described herein. The instructions 1028 can also reside, completely or at least partially, within the main memory 1004 and/or within the processing device 1002 during execution thereof by the computer system 1000, the main memory 1004 and the processing device 1002 also constituting machine-readable storage media. The machine-readable storage medium 1024, data storage system 1018, and/or main memory 1004 can correspond to a memory sub-system.

In one embodiment, the instructions 1028 include instructions to implement functionality corresponding to the BPS calculation component 1013. While the machine-readable storage medium 1024 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method for automatically assessing proximity of an enterprise's brand to a customer, comprising:
obtaining, by a processing device, a first sub-score indicative of a degree of completion of a task that involves the enterprise providing a service to the customer;
obtaining, by the processing device, a second sub-score indicative of a level of user engagement between the enterprise and the customer;
obtaining, by the processing device, a third sub-score indicative of efficiency of the task that involves the enterprise providing a service to the customer; and
combining the first sub-score, the second sub-score and the third sub-score to determine, by the processing device, a composite brand proximity score (BPS) indicative of the proximity of the enterprise's brand to the customer.

2. The method of claim 1, wherein determining the composite BPS further comprises:
generating a respective session BPS value for each engagement session with each user.

3. The method of claim 2, further comprising:
calculating a weighted average of the respective session BPS values to determine the composite BPS.

4. The method of claim 3, wherein the composite BPS represents brand proximity at a time ‘t’.

5. The method of claim 4, further comprising:
retrieving a current Brand Proximity Index (BPI) value from a BPI database, where the current BPI value in indicative of brand proximity at a time prior to time ‘t’.

6. The method of claim 5, further comprising:
applying time series smoothing to the retrieved current BPI value including the composite BPS at time T to generate an updated BPI value to store in the BPI database.

7. The method of claim 2, wherein each of the first sub-score, second sub-score and third sub-score are normalized to generate respective session BPS values.

8. The method of claim 1, wherein the first sub-score and the second sub-score are tied to each other based on user response time.

9. The method of claim 1, wherein the third sub-score is modified by applying reward function for fast completion of task.

10. The method of claim 9, wherein the reward function is a quick response reward function or a memorizing reward step function.

11. The method of claim 1, wherein the third sub-score is modified by applying penalty for non-completion of task.

12. A system for automatically assessing proximity of an enterprise's brand to a customer, the system comprising a memory, and a processor performing operations comprising:
obtaining, by a processing device, a first sub-score indicative of a degree of completion of a task that involves the enterprise providing a service to the customer;
obtaining, by the processing device, a second sub-score indicative of a level of user engagement between the enterprise and the customer;
obtaining, by the processing device, a third sub-score indicative of efficiency of the task that involves the enterprise providing a service to the customer; and
combining the first sub-score, the second sub-score and the third sub-score to determine, by the processing device, a composite brand proximity score (BPS) indicative of the proximity of the enterprise's brand to the customer.

13. The system of claim 12, wherein determining the composite BPS further comprises:
generating a respective session BPS value for each engagement session with each user.

14. The system of claim 13, further comprising:
calculating a weighted average of the respective session BPS values to determine the composite BPS.

15. The system of claim 14, wherein the composite BPS represents brand proximity at a time ‘t’.

16. The system of claim 15, wherein the operations further comprise:
retrieving a current Brand Proximity Index (BPI) value from a BPI database, where the current BPI value in indicative of brand proximity at a time prior to time T.

17. The system of claim 16, wherein the operations further comprise:
applying time series smoothing to the retrieved current BPI value including the composite BPS at time T to generate an updated BPI value to store in the BPI database.

18. The system of claim 13, wherein each of the first sub-score, second sub-score and third sub-score is normalized to generate respective session BPS values.

19. The system of claim 12, wherein the first sub-score and the second sub-score are tied to each other based on user response time.

20. The system of claim 12, wherein the third sub-score is modified by applying reward function for fast completion of task, or by applying penalty for non-completion of task.
